(19) United States
(12) Patent Application Publication
(10) Pub. No.: US 2004/0049437 A1
(43) Pub. Date: Mar. 11, 2004

(54) Method, system and computer program product for automating transaction tax calculation

(75) Inventors: Mikhail S. Brikman, Marblehead, MA (US); Daniel L. Sullivan, Marblehead, MA (US)

Correspondence Address: PERKINS, SMITH & COHEN LLP, ONE BEACON STREET, 30TH FLOOR, BOSTON, MA, 02108, US

(73) Assignee: govONE Solutions, LP, Omaha, NE

(21) Appl. No.: 10/241,322

(22) Filed: Sep. 11, 2002

(51) Int. Cl. G06F 17/60

(52) U.S. Cl. 705/31

(57) ABSTRACT

A transaction tax calculating system using a hybrid method of referring to tables providing rules for state and local tax brackets, rounding and exceptions and applying those rounding and bracket tax calculation rules in conjunction for rounding.

### BACKGROUND OF THE INVENTION

This invention relates to a method, a system, and a computer program product for automatically determining a transaction tax liability for a transaction involving the sale of products or services. The burden on sellers and buyers to comply with transaction tax laws and rules in all jurisdictions in which they do business is extraordinary, and is made complicated by the numerous taxes that may be applicable in each jurisdiction involved in the transaction. Consummated transactions may be subject to many different tax schemes, including, but not limited to, customs, excise, sales, and use taxes, gross receipts taxes, utility taxes, business and occupation taxes, and value added taxes. Federal, state, and local governments around the world have the legal authority to enact transaction taxes, and tens of thousands of taxing jurisdictions are in place today. The methods and rates of taxation vary widely and are often changed.

Transaction tax liabilities related to the consummation of a transaction are typically calculated at the time of the transaction by the seller at the seller's location at the time of transaction (either in-person or online) or with an invoice. In either case, but particularly in the case of time-of-transaction tax calculation, the requirement of resorting to multiple tax tables for different applicable jurisdictions, for which each table may be extensive, is extremely demanding even for electronic cash registers deployed at most retail locations.

Automation solutions in the past have included, as an example, U.S. Pat. No. 6,141,650, for “Sales Data Processing System Capable of Automatically Calculating Sales Taxes,” issued to Iwasa et al. the applicable tax authority, possibly an expensive administrative proposition for the purchaser. Iwasa et al. teaches the input of a tax table into an electronic cash register using an algorithm for detecting cyclical series of difference values.

Such an approach, while useful for programming an electronic cash register for one (or a relatively few tables), is not manageably extendible to the situations of online or mail order retailers who have facilities in multiple jurisdictions or multi-jurisdictional retail “chains” with centralized tax calculation, who are thus faced with multiple tables with multiple rules that are changed from time to time.

### SUMMARY OF THE INVENTION

A hybrid algorithm- and table-based system is provided in the invention to allow flexible and real-time automated transaction tax calculation. In a preferred embodiment of the invention, an invoice tax engine deconstructs an invoice into taxable line items, for each of which a line item tax engine calculates an unrounded tax on a transaction using both an algorithm and a table. A rounding function is used to calculate true total tax for accumulated line item tax and for accumulated invoice tax. That rounding function applies specific rules of the taxing jurisdiction.

### BRIEF DESCRIPTTON OF THE DRAWINGS

FIG. 1 is a data flow diagram of the invoice tax engine of the present invention;

FIG. 2 is a data flow diagram of the line item tax engine of the present invention; and

FIG. 3 is a data flow diagram of the rounding function of the present invention.

### DETAILED DESCRIPTION

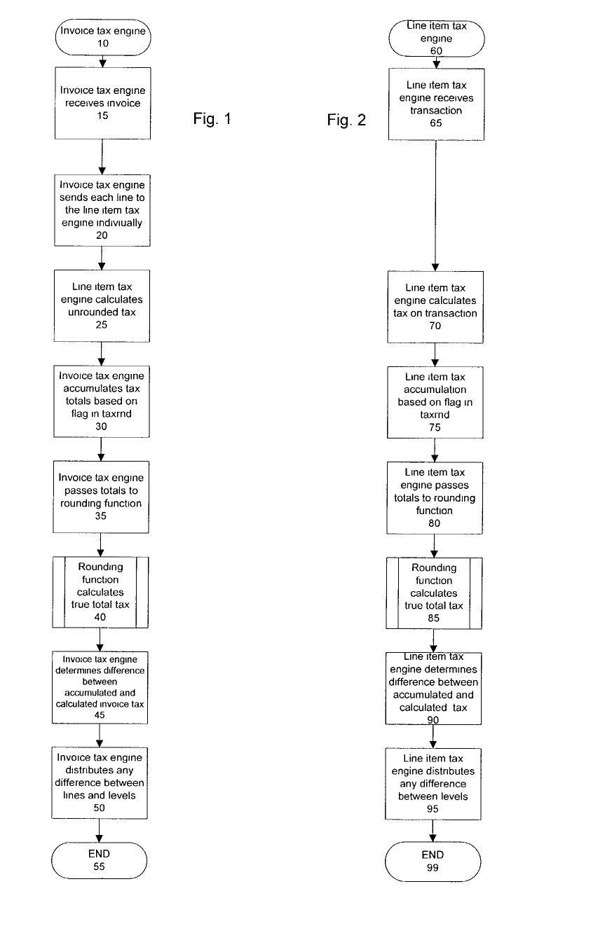

FIG. 1 shows the operation of the invoice tax engine in a specific embodiment. In the first step 15, the invoice tax engine receives an invoice in digital form. The invoice tax engine 10 then sends each line of the invoice to the line item tax engine 60 (FIG. 2) line-by-line. In step 25, shown in greater detail in FIG. 2, the line item tax engine 60 calculates the unrounded tax for the line item, generally matching the transaction represented by the invoice with a tax table (or set of rules) for a particular taxing jurisdiction among many, for example, the “taxbkt” Table 3 below, and calculating a tax according to those rules. In step 30, the invoice tax engine 10 accumulates (by repeating steps 20 and 25), according to a flag in the “taxrnd” table, which is laid out as follows:

TABLE 1
Layout of TAXRND Table

| Field | Data type | Field length |
|---|---|---|
| State | Num | 2 |
| Rate | Num | 7, 6 |
| Effective date | Num | 8, 0 |
| Expiration date | Num | 8, 0 |
| Rounding type | Char | 1 |
| Standard or exception | Char | 1 |
| Exclusion/exemption | Char | 1 |
| Exclusion threshold | Num | 7, 2 |
| Rounding Threshold | Num | 7, 2 |
| Rounding Amount-1 | Num | 7, 6 |
| Rounding Amount-2 | Num | 7, 6 |

### FIELD DESCRIPTIONS

State Code

The numeric state code. The system recognizes Canada as state code 52. The Canadian provinces are listed separately.

Rate

All states have a record with 0 in the rate field. States where the rounding varies by rate have additional rate records.

Effective Date

The date on which the rounding method became effective. The baseline effective date is 00000000.

Expiration Date

The date on which the rounding method expired. If the method is still valid, the expiration date is zeroes.

Standard or Exception:

“S” indicates that all rates in the state use the same method of rounding as the one described on the zero rate record.

“E” indicates that some form of special processing is necessary.

Rounding Type

“A” means the same as “T” except that a city or county accumulates and rounds separately from the rest of the state. As the System examines each line item to be accumulated, it compares the state, level and county or city name to the records in a supplemental table. If the name(s) are found, the System accumulates the tax for that name and level separately from the remainder of the tax. The System applies type “T” rounding rules to the accumulated exception city tax and to the accumulated “all other” tax.

“B” indicates that taxable amounts below the exclusionary threshold have no tax; taxable amounts above the non-zero rounding threshold are rounded using the rules in this table; taxable amounts between the exclusionary and rounding thresholds use the rules in table taxbkt (below).

“C” is a combination of “B” and “L”. The program accumulates and rounds taxes by level. The state total is rounded using the state's base record and rounding type “B”. The city/county totals are rounded individually using the rules on a record with the city/county rate. If the local record is not found, the program defaults to 5/4 rounding.

“L” indicates that each level of tax is to be rounded individually.

“Q” indicates that Canadian state level tax (GST) is rounded first, the result used in a tax on tax calculation, and the city level PST rounded separately. (State and city refer to the field names.)

“T” indicates the tax shall be rounded by total rate. If rounding is controlled by the UTL, it is applied to the total tax for all invoice lines with the same rate. If rounding is controlled by TAX010, it shall be applied to the total tax for each line. Example: Georgia 7%=4% county +1%+1%+1% locals. Rounding must be on the total invoice 7% tax.

“X” indicates the invoice total tax for each level is rounded as one sum. Example: In some Canadian PST provinces, the total GST and total PST are rounded separately.

Exclusion/Exemption

“T” taxable sales on or below the exemption threshold are reported as taxable.

“E” taxable sales on or below the exemption threshold are reported as exempt.

Where this is no threshold, the record will show C.

Exemption Threshold

The highest taxable sales amount at which no tax is due whether or not tax is calculated. If there is no threshold, or if there is no tax, the table will show zero.

Rounding Threshold

Tax on taxable sales above the exemption threshold but not above this threshold is rounded using the low rounding amount.

Low Rounding Amount

This amount is added to the tax amount for transactions with a taxable amount greater than the exemption threshold, and not greater than the rounding threshold.

High Rounding Amount

This amount is added to the tax amount for transactions with a taxable amount greater than the rounding threshold.

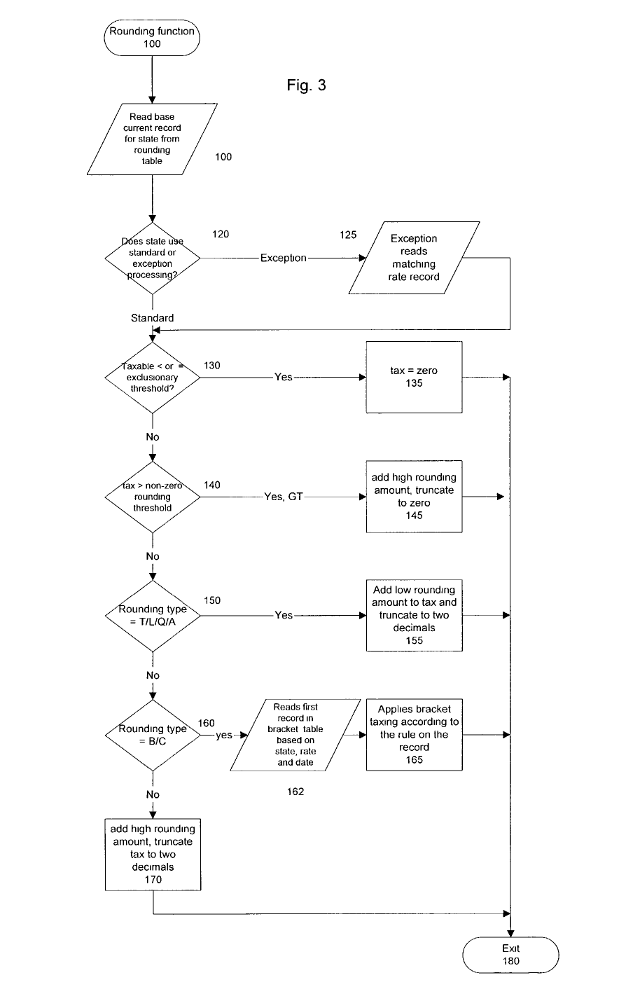

When the cycling through steps 20 and 25 is completed, in step 35, the invoice tax engine passes the totals to the rounding function 100 (FIG. 3), which, in step 40, calculates the true total tax, that is, the rounded tax. The invoice tax engine 10 then determines the difference between the accumulated and the calculated invoice tax in step 45. Finally, the invoice tax engine in step 50 distributes any difference between the line items and then between the levels of multiple tax jurisdictions that may be applicable to the transaction. If the rounded total tax in dollars and cents is not equal to the total tax produced by accumulating dollars and cents for each line item, the system applies the difference proportionately by taxable gross. The results are then returned at step 55 to a receipt or invoice generation module.

The operation of the line item (or line) tax engine 60 is shown in FIG. 2. As a first step 65, the line tax engine receives a transaction, which may be a line item or an invoice total line (here it is a line item). The line tax engine 60 then calculates tax on a transaction at step 70. The line item tax is accumulated in step 75 (which may use the same accumulator as for step 30) according to a flag in “taxrnd”. The line tax engine 60 then passes the totals (which may be multiple totals according to the flag) in step 80 to the rounding function 100 (FIG. 3). In step 85, the rounding function calculates the true total tax. The line tax engine 60 then determines the difference between the accumulated and the calculated tax in step 90 and distributes any difference between tax jurisdiction levels in step 95. (If the true tax amount is less than the accumulated amount, then reduce the lowest level with tax (secondary city upwards to state) until the two totals are the same; if the true tax amount is greater than the accumulated amount, then increase the highest level with tax (state, county, city, etc.) until the two totals are the same.) The results are passed back to the invoice tax engine 10 in step 99.

FIG. 3 shows the operation of the rounding function 100. In the first step 110, a base current record for the state is read from the rounding table “taxrnd”. At branch point 120, the rounding function 100 determines whether the state uses standard or exception processing. Exceptions are addressed using an exception table, in a particular embodiment called the “txrndexc” table. Following is a portion of the “txrndexc” table showing locations in Arkansas with a 3% applicable tax:

TABLE 2
Layout of TXRNDEXC Table

| State | Level | Code | Name |
|---|---|---|---|
| AK | 4 | A | Alakanuk |
| AK | 4 | F | Ambler |
| AK | 4 | B | Angoon |
| AK | 4 | C | Aniak |
| AK | 4 | A | Bethel |
| AK | 4 | N | Brevig Mission |
| AK | 4 | L | Chevak |
| AK | 4 | D | Diomede |
| AK | 4 | K | Emmonak |
| AK | 4 | G | Fort Yukon |
| AK | 4 | E | Galena |
| AK | 4 | D | Gambell |
| AK | 4 | F | Kotlig City |
| AK | 4 | I | Haines |
| AK | 4 | C | Ketchikan |
| AK | 4 | A | Klawock |
| AK | 4 | N | Larsen Bay |
| AK | 4 | H | Nenana |
| AK | 4 | A | Ouzinkie |
| AK | 4 | C | Palmer |
| AK | 4 | C | Petersburg |
| AK | 4 | B | Quinhagak |
| AK | 4 | J | Sandy Point |
| AK | 4 | L | Savoonga |
| AK | 4 | B | Seward |
| AK | 4 | B | Thorne Bay |

If there is exception processing, there is a branch to step 125, in which a matching rate record is read. (Thus, the system uses the “txrndexc” code field to map cities and counties to records on the “taxrnd” table using the “Standard or exception” field in the “taxrnd” table.) At branch point 130, the rounding function determines whether the taxable amount is less than or equal to an exclusion threshold (given in the “taxrnd” table) and if so, the tax is set to zero in step 135 and returned to the calling engine in step 180. If not, at branch point 140, the rounding function determines whether the tax is greater than a non-zero rounding threshold, and if so, a “high rounding amount” (provided in the “taxrnd” table) is added to the unrounded tax amount, and the result is truncated (in the same procedure as the “add high rounding amount procedure”) to zero in step 145 and returned to the calling engine in step 180. If not, at branch point 150, the rounding function determines whether the rounding type is equal to “T/L/Q/A”, and if so, a “low rounding amount” is added to the tax and the result truncated to two decimals, that is, to whole cents, at step 155 and returned to the calling engine in step 180. If not, at branch point 160, the rounding function determines whether the rounding type is “B/C”, and if so, the rounding function reads the first record in the bracket (“taxbkt”) table based on state, rate and date in step 162, applies bracket taxing according to the rule on the record in step 165, and returns the result to the calling engine in step 180. The layout of the “taxbkt” table follows:

TABLE 3
Layout of TAXBKT Table

| | | Length, | |
|---|---|---|---|
| Field | Data type | decimals | Position |
| State/Province | Num | 2 | 1-2 |
| Rate | Num | 7, 6 | 3-9 |
| Exception code | Char | 3 | 10-12 |
| Effective date | Num | 8, 0 | 13-20 |
| Upper limit of range | Num | 6, 2 | 21-26 |
| Tax amount OR Upper | Num | 6, 2 | 27-32 |
| limit of table. | | | |
| Calculation Rule OR | Char | 2 | 33-34 |
| Remainder limit | | | |
| Maximum taxable for | Num | 6, 2 | 35-40 |
| the rule OR the | | | |
| repetition factor | | | |

### FIELD DESCRIPTIONS

State Code

2-digit state code. Canada is 52. The system assigns state codes 81-93 to the Canadian provinces.

Rate

The rate for the bracket as a multiplying factor. Example: 6%=0.060000 which appears in the table as 0060000.

Exception Code

Reserved for future use; allows for additional flexibility.

Effective Date

The date on which the brackets became effective.

Upper Limit of Range

The first record for each state and rate combination contains zeroes. The other records contain the highest value of a bracket.

Tax Amount OR Upper Limit of Table

The first record for each state and rate combination has zeroes in the upper limit of range field and the upper limit of the table in this field. Other records contain the amount of tax that applies to a range.

Calculation Rule OR Remainder Limit

The calculation rule is a code indicating the bracket tax method for all taxable amounts. The remainder limit is a code indicating a change of focus during the table look-up.

Upper Limit of Rule OR the Repetition Factor

The first record for each state and rate combination contains a value indicating the limit of the rule or the repetition factor. When the field is zero, no limit applies and there is no non-standard repetition factor. When a taxable amount exceeds the value of the non-zero upper limit of the rule, the System will round the tax using the high rounding amount in table taxrnd. The value of the upper limit of rule should also be in the field known as “rounding threshold” in table taxrnd. Its presence here is a safety valve. When the base tax amount used for multiplying whole units above the upper limit of table is not the same as the last value in the table, the repetition value is used to determine the number of units and the tax on those units.

If the rounding type is not “B/C”, a “high rounding amount” stored in table is added to the unrounded tax amount and the result truncated to two decimals (to whole cents) in step 170 and returned to the calling engine at step 180.

Note that, while the example here was given of multiple taxing jurisdiction levels, the invention is applicable to different line items with different rounding rules and to combinations of such rules with different jurisdictions.

A computer system with which the various elements of the tax transaction system including the invoice tax engine 10, the line tax engine 60 and the rounding function 100 may be implemented in a variety of ways. The computer system may be a general purpose computer system which is programmable using a computer programming language, such as C, C++, Java, or other language, such as a scripting language or even assembly language. The computer system may also be specially programmed, have special purpose hardware, or have an application specific integrated circuit (ASIC).

Such a system may be implemented in software, hardware, or firmware, or any combination thereof. The various elements of the system, either individually or in combination, may be implemented as computer program product tangibly embodied in a machine-readable storage device for execution by a computer processor. Various steps of the process may be performed by a computer processor executing a program tangibly embodied on a computer-readable medium to perform functions by operating on input and generating output. Computer programming languages suitable for implementing such a system include procedural programming languages, object-oriented programming languages, and combinations of the two.

The invention is not limited to a particular computer platform, particular processor, or particular high-level programming language. Additionally, the computer system may be a multiprocessor computer system or may include multiple computers connected over a computer network. Various possible configurations of computers in a network permit many users to participate in a transaction, even if they are disbursed geographically.

Each module or step shown in the accompanying Figures and the sub-steps or subparts shown in the remaining Figures may correspond to separate modules of a computer program, or may be separate computer programs. Such modules may be operable on separate computers or other devices. The data produced by these components may be stored in a memory system or transmitted between computer systems or devices. A communication network may interconnect the plurality of computers or devices, such as a public switched telephone network or other circuit switched network, or a packet switched network such as an Internet protocol (IP) network. The network may be wired or wireless, and may be public or private.

Having now described the preferred embodiment, it should be apparent to those skilled in the art that the foregoing is merely illustrative and not limiting, having been presented by way of example only. Numerous modifications and other embodiments may be made. For example, the tax transaction system may be applied to any type of tax that must be collected and remitted, including, but not limited to telecommunications, transportation, utilities, and other transaction taxes.

What is claimed is:

1. A method for automatically calculating a transaction tax, comprising the steps of:
(a) matching a tax jurisdiction applicable to a transaction to tax-calculation rules for said tax jurisdiction provided among a table of said tax-calculation rules for multiple jurisdictions;
(b) calculating for a transaction an unrounded tax using said tax-calculation rules for said applicable tax jurisdiction;
(c) matching said applicable tax jurisdiction to tax-rounding rules for said tax jurisdiction provided among a table of said tax-rounding rules for multiple jurisdictions; and
(d) calculating for said transaction a rounded tax using said tax-rounding rules for said applicable tax jurisdiction.

2. The method of claim 1 further comprising the steps of:
(e) calculating the difference between said unrounded tax and said rounded tax; and
(f) distributing said difference according to said tax-rounding rules for said applicable tax jurisdiction.

3. The method of claim 2 wherein said transaction includes multiple taxable line items and said step of distributing said difference between rounded and unrounded tax distributes said difference among said multiple taxable line items according to said tax-rounding rules for said applicable tax jurisdiction.

4. The method of claim 1 wherein said transaction includes multiple taxable line items, said method further comprising performance of steps (a) through (d) for each said line item; accumulating resulting unrounded and rounded taxes; calculating the difference between said accumulated unrounded and rounded taxes; and distributing said difference according to the tax-rounding rules of one of said applicable jurisdictions.

5. The method of claim 4 wherein said steps of accumulating and calculating the difference between unrounded and rounded taxes are performed among said line items according to exception rules for said tax jurisdiction provided among a table of such exceptions for multiple jurisdictions.

6. The method of claim 1 wherein multiple levels of jurisdictions are applicable to said transaction, said method further comprising performance of steps (a) through (d) for each said level; accumulating resulting unrounded and rounded taxes; calculating the difference between said accumulated unrounded and rounded tax; and distributing said difference according to the tax-rounding rules of at least one of said applicable jurisdictions.

7. The method of claim 6 wherein said steps of accumulating and calculating the difference between unrounded and rounded taxes are performed among said levels of jurisdictions according to exception rules for at least one of said jurisdictions provided among a table of such exceptions for multiple jurisdictions.

8. A system for automatically calculating a transaction tax, comprising:
(a) means for matching a tax jurisdiction applicable to a transaction to tax-calculation rules for said tax jurisdiction provided among a table of said tax-calculation rules for multiple jurisdictions;
(b) means for calculating for a transaction an unrounded tax using said tax-calculation rules for said applicable tax jurisdiction;
(c) means for matching said applicable tax jurisdiction to tax-rounding rules for said tax jurisdiction provided among a table of said tax-rounding rules for multiple jurisdictions; and
(d) means for calculating for said transaction a rounded tax using said tax-rounding rules for said applicable tax jurisdiction.

9. The system of claim 8 further comprising:
(e) means for calculating the difference between said unrounded tax and said rounded tax; and
(f) means for distributing said difference according to said tax-rounding rules for said applicable tax jurisdiction.

10. The system of claim 9 wherein said transaction includes multiple taxable line items and said means for distributing said difference between rounded and unrounded tax is adapted to distribute said difference among said multiple taxable line items according to said tax-rounding rules for said applicable tax jurisdiction.

11. The system of claim 8 wherein said transaction includes multiple taxable line items, said system further comprising means for applying means (a) through (d) to each said line item; means for accumulating resulting unrounded and rounded taxes; means for calculating the difference between said accumulated unrounded and rounded taxes; and means for distributing said difference according to the tax-rounding rules of one of said applicable jurisdictions.

12. The system of claim 11 wherein said means for applying said means for accumulating and calculating the difference between unrounded and rounded taxes is adapted to apply said means among said line items according to exception rules for said jurisdiction provided among a table of such exceptions for multiple jurisdictions.

13. The system of claim 8 wherein multiple levels of jurisdictions are applicable to said transaction, said system further comprising means for applying means (a) through (d) for each said level; means for accumulating resulting unrounded and rounded taxes; means for calculating the difference between said accumulated unrounded and rounded tax; and means for distributing said difference according to the tax-rounding rules of at least one of said applicable jurisdictions.

14. The system of claim 13 wherein said means for applying said means for accumulating and calculating the difference between unrounded and rounded taxes is adapted to apply said means among said levels of jurisdictions according to exception rules for at least one of said jurisdictions provided among a table of such exceptions for multiple jurisdictions.

15. A computer program product comprising:
a computer-readable medium; and
computer program instructions stored on the computer-readable medium, wherein the computer program instructions, when executed by a computer, direct the computer to perform a process comprising the steps of:
(a) matching a tax jurisdiction applicable to a transaction to tax-calculation rules for said tax jurisdiction provided among a table of said tax-calculation rules for multiple jurisdictions;
(b) calculating for a transaction an unrounded tax using said tax-calculation rules for said applicable tax jurisdiction;
(c) matching said applicable tax jurisdiction to tax-rounding rules for said tax jurisdiction provided among a table of said tax-rounding rules for multiple jurisdictions;
(d) calculating for said transaction a rounded tax using said tax-rounding rules for said applicable tax jurisdiction;
(e) calculating the difference between said unrounded tax and said rounded tax; and
(f) distributing said difference according to said tax-rounding rules for said applicable tax jurisdiction.

16. The computer program product of claim 15 further adapted to apply steps (a) through (d) to multiple line items of a transaction, to accumulate unrounded and rounded taxes, to calculate differences between said accumulated taxes, and to distribute said differences according to exception rules for said tax jurisdiction provided among a table of such exceptions for multiple jurisdictions.

17. The computer program product of claim 15 further adapted to apply steps (a) through (d) for multiple levels of jurisdictions applicable to said transaction, to accumulate unrounded and rounded taxes, to calculate differences between said accumulated taxes, and to distribute said differences according to exception rules for at least one of said jurisdictions provided among a table of such exceptions for multiple jurisdictions.

18. A data structure comprising information designating multiple transaction tax jurisdictions and information designating transaction tax-rounding rules for those jurisdictions structurally mapped to the jurisdiction-designating information, said rules adapted for application to and accumulation for line items of a transaction or multiple levels of tax jurisdictions applicable to a transaction.
